(19) United States
(12) Patent Application Publication
(10) Pub. No.: US 2011/0141223 A1
(43) Pub. Date: Jun. 16, 2011

(54) Multiple Operating Mode Optical Instrument

(75) Inventor: Howard C. Choe, Southlake, TX (US)

(73) Assignee: Raytheon Company, Waltham, MA (US)

(21) Appl. No.: 12/483,129

(22) Filed: Jun. 11, 2009

Related U.S. Application Data
(60) Provisional application No. 61/137,656, filed on Aug. 1, 2008.
(60) Provisional application No. 61/061,472, filed on Jun. 13, 2008.

(51) Int. Cl. H04N 5/225; H04N 7/18

(52) U.S. Cl. 348/36; 348/61; 348/E07.085; 348/E05.024

(57) ABSTRACT

According to one embodiment, an optical instrument includes a hand-held housing that houses multiple optical devices and an eyepiece. The optical devices are configured to generate a corresponding multiple number of images on the eyepiece such that each image is contiguously aligned with one another along their sides to form a panoramic image on the eyepiece.

### RELATED APPLICATIONS

This application claims priority to U.S. Provisional Patent Application Ser. No. 61/137,656, entitled “HAND-HELD WIDE AREA THREAT WARNING DEVICE,” which was filed on Jun. 13, 2008. U.S. Provisional Patent Application Ser. No. 61/137,656 is hereby incorporated by reference.

This application claims priority to U.S. Provisional Patent Application Ser. No. 61/061,482, entitled “COMPOSITE COGNITIVE, BIOMIMETIC, AND NEUROMIMETIC PROCESSING,” which was filed on Jun. 13, 2008. U.S. Provisional Patent Application Ser. No. 61/061,482 is hereby incorporated by reference.

### TECHNICAL FIELD OF THE DISCLOSURE

This disclosure generally relates to optical devices, and more particularly, to an optical instrument having multiple modes of operation and a method of operating the same.

### BACKGROUND OF THE DISCLOSURE

Optical instruments are generally used to enhance imagery seen by humans. Telescopes or binoculars, for example, provide views of distant objects that may not be easily seen with the naked eye. Infrared cameras are another type of optical instrument that captures infrared energy into imagery in low-light or no light conditions. Devices such as these typically incorporate one or more lenses or mirrors that refract or reflect incoming light onto a focal plane for view by its user.

### SUMMARY OF THE DISCLOSURE

According to one embodiment, an optical instrument includes a hand-held housing that houses multiple optical devices and an eyepiece. The optical devices are configured to generate a corresponding multiple number of images on the eyepiece such that each image is contiguously aligned with one another along their sides to form a panoramic image on the eyepiece.

Particular embodiments of the present disclosure may exhibit some, none, or all of the following technical advantages. For example, an advantage of one embodiment may be a cognitive threat warning system that may provide users, such as soldiers, with an advanced hand-held threat warning system. It may improve protection and enhance persistent situational awareness by detecting threats at stand-off range giving earlier auto warnings/alerts, and reducing fatigue in searching for threats compared to known optical instruments.

Other technical advantages will be readily apparent to one skilled in the art from the following figures, description, and claims.

### BRIEF DESCRIPTION OF THE DRAWINGS

A more complete understanding of embodiments of the disclosure will be apparent from the detailed description taken in conjunction with the accompanying drawings in which:

FIG. 1 is a diagram shows one embodiment of an optical instrument according to the teachings of the present disclosure;

FIG. 2 is a diagram showing one embodiment of the image processing unit of FIG. 1; and

FIGS. 3A, 3B, and 3C show a front perspective, a rear perspective, and an exploded view, respectively, of one embodiment of a housing that may be used to house the various elements of the optical instrument of FIG. 1.

### DETAILED DESCRIPTION OF EXAMPLE EMBODIMENTS

Known optical instruments are often dedicated to a particular purpose. For example, telescopes and binoculars are both well suited to magnify images of distant objects, yet they may be adapted to serve differing purposes. While known implementations of binoculars typically have less magnification then telescopes, they are often smaller and provide imagery to both eyes of a user for enhanced visualization of terrestrial features. Neither of these optical instruments, however, provide multiple optical paths that may be contiguously aligned with one another along their lateral extent to provide a panoramic view for the user.

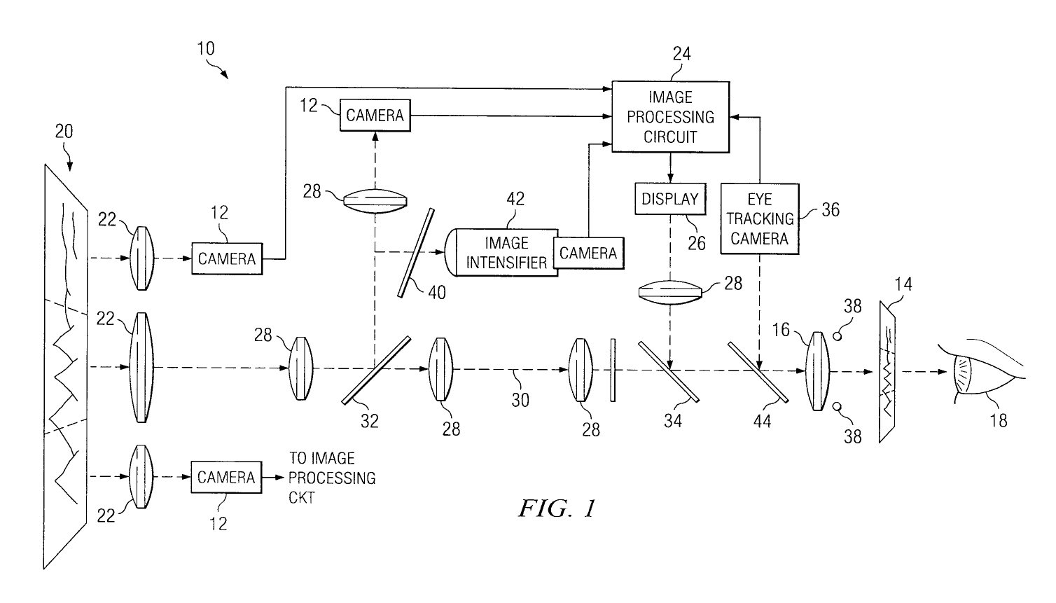

FIG. 1 is a diagram that shows one embodiment of an optical instrument 10 according to the teachings of the present disclosure. Optical instrument 10 includes multiple optical devices 12 that generate an image on a display 26 that is projected as a projected image 14 through a mirror 34 and an eyepiece 16 onto the eye 18 of a user. The image generated by each optical device 12 represents light reflected or emitted from one or more objects in a scene 20 that in the particular example shown, includes a terrestrial landscape. According to the teachings of the present disclosure, image formed by each optical device 12 is contiguously aligned with one another along their lateral extent to form a panoramic view of projected image 14 on eyepiece 16.

Certain embodiments incorporating multiple optical devices 12 may provide an advantage in that a relatively wide field-of-view may be provided with a relatively low amount of distortion. One reason multiple optical devices 12 may have relatively less distortion than other known devices may be due to multiple optical paths from which to generate the relatively wide field-of-view. Another reason may be that, because each optical device 12 forms an optical path that is independent of the other optical devices 12, it may be independently adjusted to minimize distortions, such as those caused by improper focus adjustment on objects that may exist at varying distances. As will be described in detail below, independent operation of each optical device 12 may also incorporate additional modes of operation for certain optical devices 12 configured in optical instrument 10.

Optical devices 12 may be any suitable device that renders an image of scene 20 on eyepiece 16. In the particular embodiment shown, each optical device 12 includes a video camera optically coupled to an objective lens 22. Each video camera generates a signal representative of a portion of scene 20 that may be processed by an image processing unit 24. A display device 26 receives light from scene 20 and generates the projected image 14 that is displayed on eyepiece 16. In one embodiment, each video camera may be a multi-aperture imaging system incorporating multiple relatively small video cameras. The signals generated by these relatively small cameras may be combined by image processing unit 24 to form a combined image with greater image quality than each individual image.

In one embodiment, optical devices 12 incorporate an instantaneous field-of-view (IFOV) with a minimum of 50 micro-radians per pixel. Using this instantaneous field-of-view, a four pixel (e.g., 2 by 2 pixel array) image may correspond to a 1 square meter (1 meter²) view at a range of approximately 10 Kilometers. Optical devices 12 having a 50 micro-radian IFOV may provide about 8 to 12 pixels on typical objects in scene 20 that are approximately 1 meter by 2 meters by 3 meters in size, such a typical passenger car. Thus, optical devices 12 having a 50 micro-radian IFOV may provide an adequate number of pixels on objects in scene 20 for a typical moving vehicle at 10 Kilometers away.

Optical instrument 10 may have multiple display modes. One display mode may include a full-view mode in which each optical device 12 has an essentially equal magnification. In one embodiment, each optical device 12 may have a field-of-view of approximately 45 degrees in which the three optical devices 12 configured together provide an overall field-of-view of approximately 120 degrees. In other embodiments, optical instrument 10 may include a split display mode and/or a night viewing mode. In the split display mode of operation, centrally configured optical device 12 may incorporate a power and/or manual zoom feature for independent adjustment of its magnification. In this manner, the centrally configured optical device 12 may have a magnification that is selectable from a lower magnification having a 45 degree field-of-view to an upper magnification with a magnification factor of approximately 100. Thus, image 14 may be displayed as individual segments on eyepiece 16 while in the split display mode. The split display mode may address characteristic movements of the human eye in which the centrally configured optical device 12 may have a field-of-view approximating saccadic eye movement while the outer optical devices 12 have a field-of-view approximating typical eye-head gaze shifts at relatively larger eccentricities. Saccadic eye movements are abrupt movements of the human eye that are made to acquire targets within approximately 15 to 22 degrees of its central position.

In one embodiment, centrally configured optical device 12 includes multiple lenses 28 that optically couple its associated objective lens 22 to eyepiece 16 to form an optical path 30. Two movable mirrors 32 and 34 selectively reflect light in optical path 30 to video optical device 12 and eyepiece 16, respectively. While in a first position, movable mirrors 32 and 34 are moved away from optical path 30 to allow light from objective lens 22 to proceed directly to eyepiece 16. In a second position, movable mirror 32 reflects light from light path onto optical device 12 and eyepiece 16 such that little or no light arrives at eyepiece 16 from optical path 30. Thus, centrally configured optical device 12 may be alternatively configured to display the light directly received by objective lens 22 or display light generated by display device 26 using the signal generated by its associated optical device 12. Certain embodiments may provide an advantage in that optical instrument 10 may have utility if electrical power to optical device 12, image processing unit 24, and display device 26 are lost. That is, optical instrument 10 may incorporate a direct view optical assembly in which electrically powered elements may be bypassed.

In one embodiment, optical instrument 10 includes an eye tracking camera 36 and one or more infrared light sources 38 for monitoring the orientation of the eye 18. Eye tracking camera 36 receives light from the user's eye 18 through a mirror 44 and generates an electrical signal indicative of an image of the eye 18 that may be received and processed by image processing unit 24. Infrared light sources 38 may be used to illuminate the eye 18. Eye tracking camera 36 may be used by image processing unit 24 to determine what the eye 18 is looking at in projected image 14 and other characteristics of the eye 18, such as pupil dilation.

In one embodiment, display device 26 is a retinomimetic display in which a foveal instantaneous field-of-view of approximately 2 to 3 degrees or other suitable instantaneous field-of-view angles may be provided at the location on the display in which the user's eye is looking. That is, optical instrument 10 may track the motion of the eye to maintain the highest density pixel count wherever the eye is actually looking. In another embodiment, optical instrument 10 has a single display for view by both eyes or two displays for each eye of the user.

In another embodiment, optical instrument 10 include another movable mirror 40 that is selectively movable from a first position in which light in the optical path may pass freely to optical device 12 to a second position in which light from the light path is directed to an image intensifying camera 42. Image intensifying camera may be any suitable device, such as an image intensifier tube (IIT) camera that amplifies light in low-light conditions. Any suitable image intensifying camera 42 may be used, such as, but not limited to a short-wavelength infrared (SWIR) camera or a low-light charge-coupled device (CCD) camera. In some cases, low-light charge-coupled device may operate in low-light conditions of approximately 0.00005 lux.

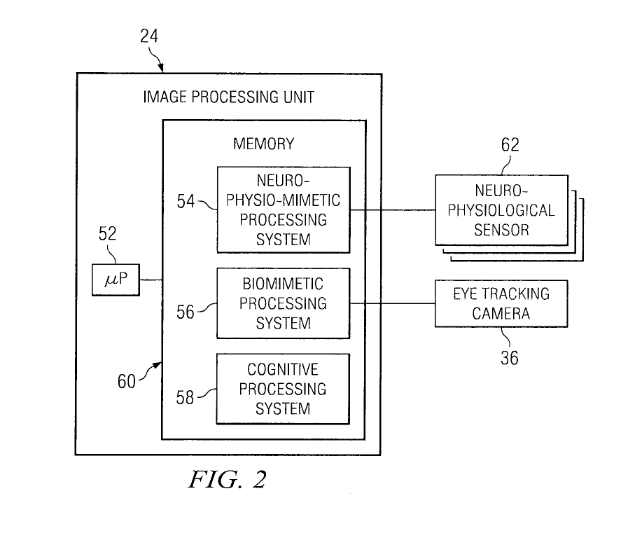

FIG. 2 is a diagram showing one embodiment of the image processing unit 24 of FIG. 1. Image processing unit 24 includes a processor 52 executing a neuro-physio-mimetic processing system 54, a biomimetic processing system 56, and a cognitive processing system 58 that are stored in a memory 60. Various combined operations of neuro-physio-mimetic processing system 54, biomimetic processing system 56, and cognitive processing system 58 may be used by optical instrument 10 to provide additional information to its user on eyepiece 16 through display 26.

Neuro-physio-mimetic processing system 54 is coupled to one or more neuro-physiological sensors 62 that monitor various neuro-physiological aspects of the user. For example, one neuro-physiological sensor may include an electro-encephalogram (EEG) sensor that monitors brain wave activity of its user. Other types of neuro-physiological aspects monitored by neuro-physiological sensors may include the user's heart rate, respiration, perspiration, posture, or body temperature. Neuro-physio-mimetic processing system 54 receives signals from neuro-physiological sensors 62 and also from eye tracking camera 36 and processes the received signals to derive neuro-physiological information about the user that may be related to objects viewed in eyepiece 16.

Biomimetic processing system 56 may be coupled to eye tracking camera 36 and display device 26 for associating eye activity with various images displayed by display device 26. Biomimetic processing system 56 receives signals from eye tracker camera 26 and determines various characteristics of the eye 18, such as its orientation and/or pupil dilation.

Cognitive processing system 58 is coupled to neuro-physio-mimetic processing system 54, biomimetic processing system 56, and display device 26 for determining various types of useful information about objects in scene 20 displayed on display device 26. That is, cognitive processing system 58 may associate particular neuro-physiological aspects of the user or actions of the eye 18 to provide additional information. For example, a particular object in scene 20, such as a military tank may be rendered on display device 26. When viewed, the eye 18 may develop a momentary orientation toward the military tank. Biomimetic processing system processes this information to generate a visible marker that is displayed on display device 26 that is proximate the location of the military tank. In this manner, optical instrument 10 may provide a warning mechanism for particular objects in scene 20 that, in some cases, may be faster than provided through normal cognitive thought processes of the user in some embodiments.

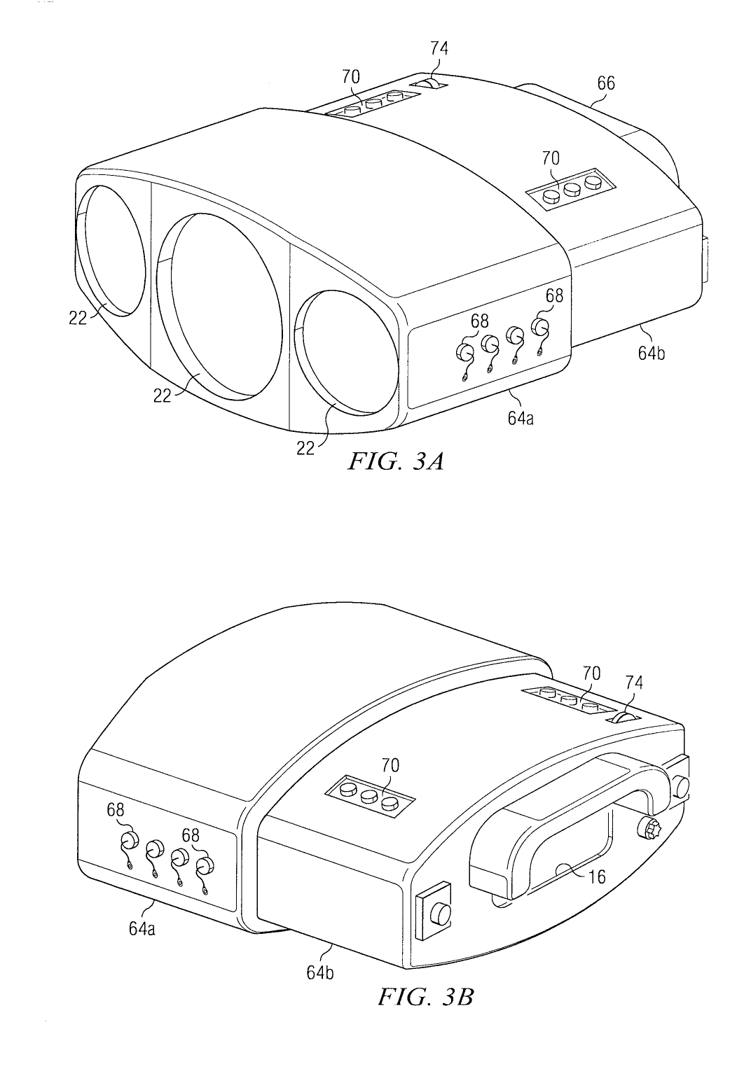

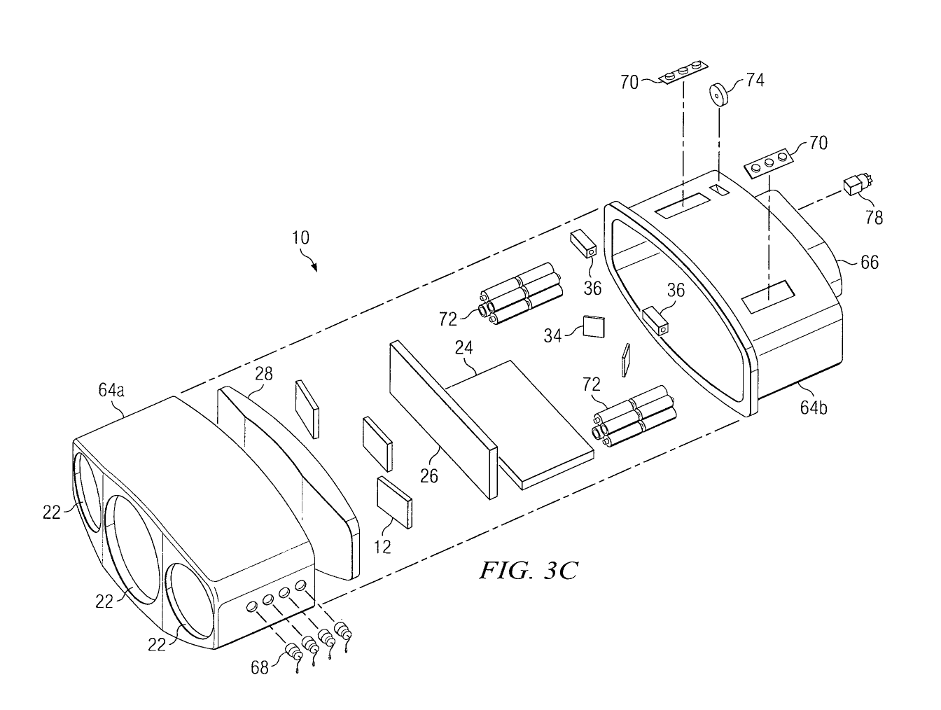

FIGS. 3A, 3B, and 3C show a front perspective, a rear perspective, and an exploded view, respectively, of one embodiment of a housing 64 that may be used to house the various elements of optical instrument 10. Housing includes a front portion 64a and a rear portion 64b that may be assembled together for operation of optical instrument 10 or separated as shown in FIG. 3C. Housing 64 may also include a visor 66 that extends outwardly from housing 64 proximate eyepiece 16 for reduced glare during daytime viewing. In the particular embodiment shown, housing 64 is configured to be handled by the hands of its user and is approximately 1 foot wide by 1 foot long by 0.5 feet in depth. Housing 64 includes, one or more neuro-physiological sensor connectors 68, one or more function buttons 70, several batteries 72, and a manual on/standby/off switch 74. Neuro-physiological sensor connectors 68 may be used to receive signals from various neuro-physiological sensors configured on the user.

Modifications, additions, or omissions may be made to visual detection system 10 without departing from the scope of the disclosure. The components of visual detection system 10 may be integrated or separated. For example, optical devices 12, image processing unit 24, and display device 26 may be provided in a single housing 64 as shown in FIGS. 3A and 3B or may be provided as independently housed units. Moreover, the operations of visual detection system 10 may be performed by more, fewer, or other components. For example, image processing unit 24 may include other components, such as filtering mechanisms that sharpen the image or provide other imaging filtering techniques to the generated image. Additionally, operations of image processing unit 24 may be performed using any suitable logic comprising software, hardware, and/or other logic.

Although the present disclosure has been described in several embodiments, a myriad of changes, variations, alterations, transformations, and modifications may be suggested to one skilled in the art, and it is intended that the present disclosure encompass such changes, variations, alterations, transformations, and modifications as falling within the spirit and scope of the appended claims.

What is claimed is:

1. An optical instrument comprising:
a hand-held housing;
three video cameras configured in the hand-held housing that are operable to generate three images on an eyepiece configured in the housing, each image contiguously aligned with one another along their sides to form a panoramic image on the eyepiece;
a first movable mirror operable to selectively reflect light from an objective lens to one of the three video cameras while in a first position and allow light from the objective lens to proceed to the eyepiece while in a second position, the one camera centrally disposed between the two other video cameras;
a second movable mirror operable to reflect light from a display to the eyepiece while in the first position and allow light to proceed from the objective lens to the eyepiece while in the second position.
an image intensifying device optically coupled to an objective lens through a third movable mirror, the movable mirror operable to reflect light from the objective lens to the image intensifying device while in a third position and allow light to pass from the objective lens to the one video camera while in a fourth position.

2. An optical instrument comprising:
a hand-held housing; and
a plurality of optical devices configured in the hand-held housing that are operable to generate a corresponding plurality of images on an eyepiece configured in the housing, each image contiguously aligned with one another along their sides to form a panoramic image on the eyepiece.

3. The optical instrument of claim 2, wherein the plurality of optical devices comprises a plurality of video cameras and the plurality of images comprises a plurality of video images generated by the plurality of cameras.

4. The optical instrument of claim 2, further comprising an objective lens and a movable mirror optically coupled to an image intensifying device and one of the plurality of optical devices, the movable mirror operable to reflect light from the objective lens to the image intensifying device while in a first position and allow light from the objective lens to proceed to the one optical device while in a second position.

5. The optical instrument of claim 4, wherein the image intensifying device comprises a night vision camera.

6. The optical instrument of claim 2, further comprising an objective lens optically coupled to one of the plurality of optical devices through a first movable mirror and a display optically coupled to the eyepiece through a second movable mirror, the one optical device comprising a video camera operable to generate an electrical signal representative of one image that is displayed on the display, the first movable mirror operable to reflect light from the objective lens to the video camera while in a first position and allow light from the objective lens to proceed to the eyepiece while in a second position, the second movable mirror operable to reflect light from a display to the eyepiece while in the first position and allow light from the objective lens to proceed to the eyepiece while in the second position.

7. The optical instrument of claim 2, wherein the plurality of optical devices comprises a first optical device and two second optical devices, the first optical device configured to generate its associated image in between the images generated by the two second optical devices, the first optical device comprising an adjustable field-of-view.

8. The optical instrument of claim 2, wherein the plurality of optical devices comprises three optical devices configured to generate three images, each image having a lateral field-of-view of at least 45 degrees, the panoramic image having at least a 120 degree field-of-view.

9. The optical instrument of claim 2, further comprising an image processing unit coupled to an eye tracker camera, the eye tracker camera optically coupled to the eyepiece, the image processing unit operable to:
receive a signal from the eye tracker camera indicative of the orientation of an eye viewing the eyepiece;
associate the signal with one or more elements in the image generated by one of the optical devices; and
generate a marker element on the eyepiece proximate the one or more elements.

10. A method comprising:
generating, on an eyepiece, a plurality of images using a plurality of optical devices configured in a hand-held housing that houses the eyepiece; and
contiguously aligning each of the plurality of images with one another along their sides to form a panoramic image on the eyepiece.

11. The method of claim 10, wherein generating the plurality of images using the plurality of optical devices comprises generating a plurality of video images using a plurality of video cameras.

12. The method of claim 10, further comprising:
alternatively reflecting light, using a movable mirror, between a night vision camera that generates one of the plurality of images and a video camera that generates the one image; and
displaying the one image on the eyepiece.

13. The method of claim 12, wherein reflecting light to an image intensifying device comprises reflecting light to a night vision camera.

14. The method of claim 10, further comprising
alternatively reflecting incoming light, using a first movable mirror, between one of the plurality of optical devices and the eyepiece, the one optical device comprising a video camera, the incoming light received through an objective lens; and
alternatively reflecting a second light, using a second movable mirror, from a display or the objective lens to the eyepiece.

15. The method of claim 10, wherein contiguously aligning each of the plurality of images with one another comprises contiguously aligning two second images of the plurality of images on either side of a first image of the plurality of images, and adjusting a field-of-view of the first image.

16. The method of claim 10, wherein generating the plurality of images using a plurality of optical devices comprises generating three images that each have a lateral field-of-view of at least 45 degrees, the panoramic image having at least a 120 degree field-of-view.

17. The method of claim 10, further comprising:
receiving a signal from an eye tracker camera indicative of the orientation of an eye viewing the eyepiece;
associating the received signal with one or more elements in the image generated by one of the optical devices; and
generating a marker element on the eyepiece proximate the one or more elements.
